(19) United States
(12) Patent Application Publication
(10) Pub. No.: US 2006/0154222 A1
(43) Pub. Date: Jul. 13, 2006

(54) Systems and methods for altering behavior by issuing messages

(76) Inventors: Stephen S. Lane, McLean, VA (US); Kevin Strauss, Columbia, MD (US)

Correspondence Address: ARENT FOX PLLC, 1050 CONNECTICUT AVENUE, N.W., SUITE 400, WASHINGTON, DC, 20036, US

(21) Appl. No.: 11/326,578

(22) Filed: Jan. 6, 2006

Related U.S. Application Data
(60) Provisional application No. 60/641,433, filed on Jan. 6, 2005.

(51) Int. Cl. G09B 23/28

(52) U.S. Cl. 434/262

(57) ABSTRACT

A method for automatically playing and/or displaying audio and/or visual messages reminding persons to engage in a particular activity or to refrain from engaging in the particular activity includes the steps of at a health care facility, selecting a first audio/visual message associated with the particular activity, and at the health care facility, selecting a second audio/visual message associated with the particular activity, which is different than the first audio/visual message. The method also includes the step of at the health care facility, playing/displaying the first audio/video message during a first period of time to a person in a particular area independent of an activity of the person in the particular area. Moreover, the method includes the step of at the health care facility, playing/displaying the second audio/video message during a second period of time after the first period of time to the person in the particular area independent of the activity of the person in the particular area. Specifically, each of the first audio message and the second audio message reminds the person in the particular area to engage in the particular activity or to refrain from engaging in the particular activity.

The present application claims priority from U.S. Provisional Patent Application No. 60/641,433, which is entitled “Systems and Methods for Altering Behavior by Issuing Messages,” and was filed on Jan. 6, 2006, the disclose of which is incorporated by reference in its entirety.

### FIELD OF THE INVENTION

The present invention relates generally to systems and methods for altering behavior by issuing messages. In particular, the present invention is directed towards systems and methods in which messages, e.g., audio and/or visual messages, automatically are generated to remind persons to engage in certain activities, e.g., to wash their hands, to avoid engaging in certain activities, e.g., smoking, and/or to have certain feelings, e.g., happiness or high self esteem.

### BACKGROUND OF THE INVENTION

Infections, including nosocomial infections, are prevalent in all patient care facilities including hospitals and nursing homes. A nosocomial infection may be defined as a localized or systemic condition that 1) resulted from adverse reaction to the presence of an infection agent or its toxin, and 2) was not present or incubating at the time of admission to the hospital. Research reveals that several types of microorganisms can be transferred by hand to live hosts, thereby producing nosocomial infections.

Nosocomial infections delay healing, extend the length of hospitalization and increase the cost of care. Each year, approximately 2.4 million Americans acquire a nosocomial infection and 100,000 persons die as a result of such infections.

Hand washing is an important element of hospital infection control. Failure to conduct handwashing after toileting or prior to or after contact with a patient places patients and health care workers at increased risk for the development of nosocomial infections. While health care workers play a powerful role in reducing nosocomial infections, they also have been implicated in contributing to the increase in nosocomial infections by failing to perform handwashing prior to or after contact with a patient and after handling contaminated materials. Although health care workers are required to participate in annual infection control in-service inspections, there is a discrepancy between classroom knowledge and applied knowledge of infection control. This discrepancy suggests that innovative strategies in infection control should be created in order to reduce the rate of nosocomial infections.

### SUMMARY OF THE INVENTION

The present invention provides a system and method that automatically reminds persons to engage in certain activities, to refrain from engaging in certain activities, and/or to have certain feelings. For example, the system and method automatically may issue reminders to hospital employees to wash their hands. Such reminders may be issued independent of whether the hospital employee actually needs to wash their hands, e.g., the reminder may be a random reminder or may be a reminder issued at predetermined time intervals, or a combination thereof. Reminders may be verbal messages played over loudspeakers, illuminated signs which turn on and off, non-illuminated signs which are displayed or hidden mechanically, or may be generated by any means for communicating a message.

Reminders that may be generated according to the present invention are not limited to reminders associated with activities or behavior that should or should not occur in a health care environment. For example, reminders may be associated with activities or behavior that animals should not engage in, e.g., an automatic reminder to an animal to stay away from the front door. Other reminders may be directed to activities or behavior associated with children, e.g., an automatic reminder to a child to be nice to their sister or brother. Additional reminders may be associated with emotions rather than behavior, e.g., an automatic reminder designed to make people feel better about themselves. However, those of ordinary skill in the art readily will understand that the above-described reminders merely are exemplary reminders, and the reminders in the present invention may be any reminder that is associated with behavior, emotions, activities, or any combination thereof.

Generally, the reminders may be non-coercive, non-threatening, and may not identify individuals, and serve the purpose of reminding a person to engage in a particular activity, e.g., hand washing, if they have not done so recently. Some examples of phrases that may be delivered in the reminder are “please remember to wash your hands after patient contact,” “good hand hygiene is the cornerstone of infection control,” and “wash your hands with soap and water if they are soiled or with alcohol sanitizer otherwise.” Nevertheless, users of the system and method of the present invention may specify their own messages, and the messages may deliver any language desired by the user. Messages to listeners also may include language that addresses common listener objections to hand washing, e.g., not enough time, the patient has immediate needs, rather than language that merely encourages the listener to wash their hands.

Moreover, consecutively issued reminders may differ from one another in either a random or a regular pattern. This may decrease the monotony of the reminders, and may increase the likelihood that persons who see or hear the reminder may take action in accordance with the reminder and will not ignore the reminder. For example, a first verbal message can be delivered by a female speaker, and a second verbal message can be delivered by a male speaker or a different female speaker; a first visual message can be delivered in a first color, font, and/or size, and a second visual message can be delivered in a second color, font, and/or size; or a first verbal and/or visual message may include a first phrase and a second verbal and/or visual message may include a second phrase that is different than the first phrase. Messages can be delivered in different texts and languages and can be delivered 24 hours a day or can be discontinued during specified hours, e.g., at night.

Similarly, consecutive reminders may differ from each other in terms of the type of behavior, activity, or emotion that they address. For example, a first reminder may be associated with hand washing, and a second reminder issued after the first reminder may be associated with smoking.

In any embodiment of the present invention, the user can download new message schedules for the system and/or new messages for the system to deliver. Thus, in the present invention, messages generally are not delivered in a static fashion, i.e., without change over time, such as by a printed sign, but instead may be delivered in ever-changing formats and can be conveniently updated and modified at the users desire.

### BRIEF DESCRIPTION OF THE DRAWINGS

This invention will be described in detail with reference to the accompanying drawings wherein:

FIG. 1 is an illustration of a system for automatically reminding persons to engage in a predetermined activity installed in a hospital hallway and in patient rooms according to an embodiment of the present invention.

FIG. 2 is an illustration of an audio device for automatically delivering verbal reminders according to an embodiment of the present invention.

FIG. 3 is an illustration an illumination device for automatically delivering visual reminders according to an embodiment of the present invention.

FIG. 4 is an illustration of a non-illuminated, mechanical device for automatically delivering visual reminders according to an embodiment of the present invention.

### DETAILED DESCRIPTION OF PREFERRED EMBODIMENTS

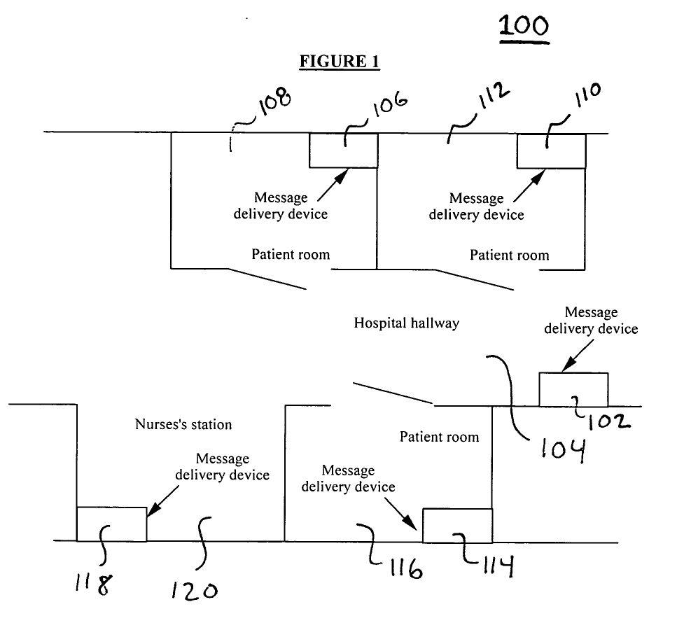

FIG. 1 shows an arrangement 100 that includes a plurality of systems for automatically reminding persons to engage in a predetermined activity according to an embodiment of the present invention. In FIG. 1, a first system 102 is installed in a hospital hallway 104, a second system 106 is installed in a first patient room 108, a third system 110 is installed in a second patient room 112, a fourth system 114 is installed in a third patient room 116, and a fifth system 118 is installed in a nurse's station 120. Each of the systems depicted in FIG. 1 are configured to automatically generate messages to remind persons to engage in the predetermined activity, e.g., to wash their hands. In general, a system that employs verbal messages may be most suitable for hallways because traffic there is likely to be health care workers who will not be disturbed by the sound of the messages. Moreover, because patients that are asleep may be disturbed by audible messages, a system that employs visual messages may be more appropriate in a patient room. However, in the present invention, hospitals or other entities may install any system for automatically reminding persons to engage in a predetermined activity in any location.

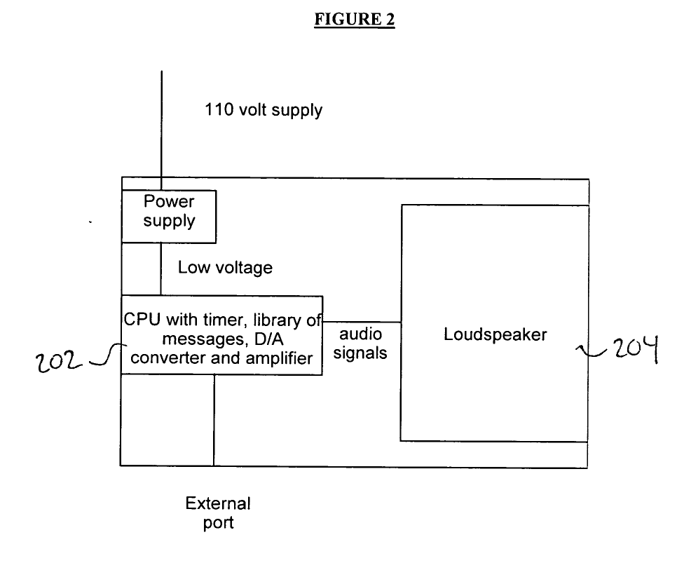

Referring to FIGS. 1 and 2, in an embodiment of the present invention, at least one of the systems of FIG. 1 for automatically reminding persons to engage in the predetermined activity generates verbal messages to remind persons to engage in the predetermined activity. For example, the at least one system may be the system located in the hallway 104 of FIG. 1. The at least one system may be attached to a wall near a 110-volt electrical outlet, from which it gets its power, or alternatively, each system may be battery powered. The at least one system may comprise a timer 202, pre-recorded messages on a suitable medium, a means to play those messages over a loudspeaker 204, and the loudspeaker 204. The timer 202 directs the playing means to play a message in its library, chosen there either at random or according to a schedule, at either random time intervals or fixed time intervals. On being so directed, the playing means plays the message at a volume that is sufficient for nearby listeners to clearly hear the message. An external port is available for a user to download different messages and alter message delivery schedule. The at least one system may be positioned sufficiently high enough on a wall so as not to interfere with passage through the hallway, and may be spaced so that the at least one system can be heard at any point along the hallway 104.

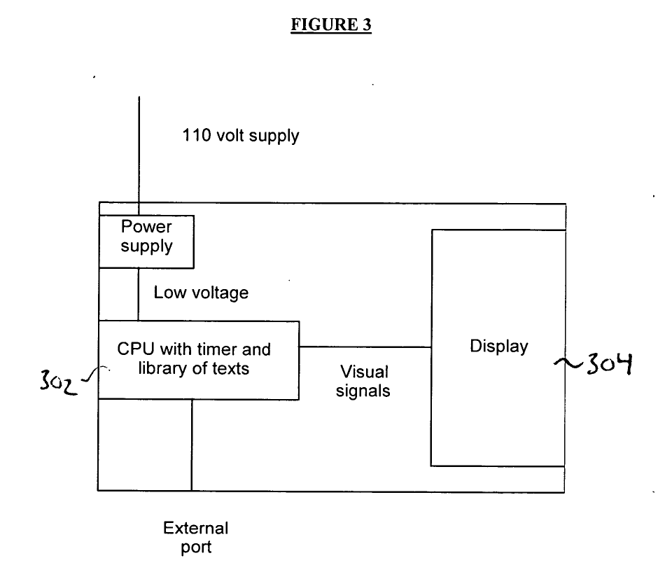

Referring to FIGS. 1 and 3, in an embodiment of the present invention, at least one of the systems of FIG. 1 for automatically reminding persons to engage in the predetermined activity displays illuminated messages to remind persons to engage in the predetermined activity. For example, the at least one system may be the system located in one of the patient rooms of FIG. 1. The at least one system may be attached to a wall near a 110-volt electrical outlet, from which it gets its power, or alternatively, each system may be battery powered. The at least one system may comprise a timer 302, pre-recorded signs on a suitable medium, a means to display those signs on a screen 304, and the screen 304. The timer 302 directs the displaying means to display a message chosen according to a schedule from its library at either random time intervals or fixed time intervals. On being so directed, the displaying means shows the message on the screen 304 for a predetermined amount of time, and then removes it until the next message is to be displayed. Alternatively, the next message may be displayed immediately. A chime or other sound may alert listeners to the presence of a new message. An external port is available so that a user can download different messages and alter message delivery schedule. The at least one system may be positioned sufficiently high enough on a wall so as not to interfere with passage within the room, and may be spaced so that the at least one system can be seen at any point in the room.

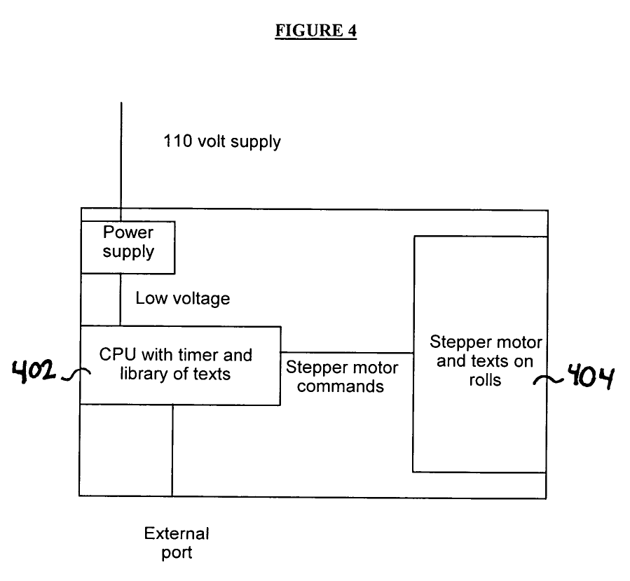

Referring to FIGS. 1 and 4, in an embodiment of the present invention, at least one of the systems of FIG. 1 for automatically reminding persons to engage in the predetermined activity generates messages to remind persons to engage in the predetermined activity using a mechanical sign. For example, the at least one system may be the system located in one of the patient rooms of FIG. 1. The at least one system may be attached to a wall near a 110-volt electrical outlet, from which it gets its power, or alternatively, each system may be battery powered. The at least one system may comprise a timer 402 with a catalog of signs, pre-recorded signs printed on a screen wound onto rollers and a stepping motor 404 to drive the rollers. The timer 402 directs the stepping motor 404 to move the rollers to the desired message, according to a schedule from its library at either random time intervals or fixed time intervals. Blank signs may be presented between printed messages in order to reduce monotony in the viewer, or alternatively, the next message may be displayed immediately. A chime or other sound may alert listeners to the presence of a new message. An external port is available so that a user can alter message delivery schedule.

In any of the above-described embodiments of the present invention, the message from one delivery to the next may be altered, such that the exact same message is not repeated in consecutive messages. Specifically, it is a truism of communications theory that an unchanging signal delivers no information. Hence signs posted on restroom walls reminding users to wash their hands may become ineffective after a short amount of time because their message never changes. The system of the present invention may be configured to vary its message as much as possible, by for example playing voice messages with different person's voices; by playing messages with different texts; by displaying messages with different texts, color, fonts, and/or size; or by playing and/or displaying messages at irregular or random times. These variations minimize the monotony of the message, which increases the likelihood that the reminder will be heeded rather than be ignored after just a few observations.

Although various embodiments have been discussed, it is to be understood that while certain forms of the present invention, such as means for audio/visual warnings, have been illustrated, the invention is not to be limited to the specific forms or arrangements of parts described or shown. Although an inpatient environment has been described herein, the method and system is also applicable to other environments where hygiene is important such as food service or day care facilities. Further, the method and apparatus can easily be adapted to modify other behaviors, by changing the message. Some examples are reminders to refrain from smoking and reminders to exercise regularly and to refrain from snacking in obese persons. Given the above disclosure, many other features, modifications and improvements will become apparent to one skilled in the art.

1. A system for automatically displaying visual messages reminding persons to engage in a particular activity or to refrain from engaging in the particular activity, comprising:
means for selecting a first visual message associated with the particular activity and a second visual message associated with the particular activity, which is different than the first visual message; and
means for selectively displaying each of the first visual message and the second visual message, wherein the means for selectively displaying each of the first visual message and the second visual message is positioned in a particular area and is configured to be viewed by a person in the particular area, wherein the means for selectively displaying each of the first visual message and the second visual message is configured to display the first visual message during a first period of time and to display the second visual message during a second period of time independent of an activity of the person in the particular area, and wherein each of the first visual message and the second visual message reminds the person in the particular area to engage in the particular activity or to refrain from engaging in the particular activity.

2. The system of claim 1, wherein the means for selectively displaying each of the first visual message and the second visual message is configured to display each of the first visual message and the second visual message at predetermined time intervals.

3. The system of claim 1, wherein the means for selectively displaying each of the first visual message and the second visual message is configured to display each of the first visual message and the second visual message at random time intervals.

4. The system of claim 1, wherein the particular activity is associated with hand hygiene.

5. The system of claim 1, wherein the particular area is one of a room and a hallway associated with a hospital.

6. The system of claim 1, wherein the means for selectively displaying each of the first visual message and the second visual message comprises an illuminated sign.

7. The system of claim 1, wherein the means for selectively displaying each of the first visual message and the second visual message comprises a mechanical sign.

8. A method for automatically displaying visual messages reminding persons to engage in a particular activity or to refrain from engaging in the particular activity, comprising the steps of:
selecting a first visual message associated with the particular activity;
selecting a second visual message associated with the particular activity, which is different than the first visual message;
displaying the first visual message during a first period of time to a person in a particular area independent of an activity of the person in the particular area; and
displaying the second visual message during a second period of time after the first period of time to the person in the particular area independent of the activity of the person in the particular area, wherein each of the first visual message and the second visual message reminds the person in the particular area to engage in the particular activity or to refrain from engaging in the particular activity.

9. The method of claim 8, wherein the steps of displaying the first visual message and displaying the second visual message comprise the substeps of displaying the first visual message and the second visual message at random time intervals.

10. The method of claim 8, wherein the particular activity is associated with hand hygiene.

11. The method of claim 8, wherein the particular area is one of a room and a hallway associated with a hospital.

12. The method of claim 8, wherein each of the first visual message and the second visual message are displayed via an illuminated sign.

13. The method of claim 8, wherein each of the first visual message and the second visual message are displayed via a mechanical sign.

14. A method for automatically displaying visual messages reminding persons to engage in a particular activity or to refrain from engaging in the particular activity, comprising the steps of:
at a health care facility, selecting a first visual message associated with the particular activity;
at the health care facility, selecting a second visual message associated with the particular activity, which is different than the first visual message;
at the health care facility, displaying the first visual message during a first period of time to a person in a particular area independent of an activity of the person in the particular area; and
at the health care facility, displaying the second visual message during a second period of time after the first period of time to the person in the particular area independent of the activity of the person in the particular area, wherein each of the first visual message and the second visual message reminds the person in the particular area to engage in the particular activity or to refrain from engaging in the particular activity.

15. The method of claim 14, wherein the particular activity is associated with hand hygiene.

16. The method of claim 15, wherein the health care facility comprises a hospital.

17. A system for automatically playing audio messages reminding persons located in a particular area to engage in a particular activity or to refrain from engaging in the particular activity, comprising:
means for selecting a first audio message associated with the particular activity and a second audio message associated with the particular activity, which is different than the first audio message; and
means for selectively playing each of the first audio message and the second audio message, wherein the means for selectively playing each of the first audio message and the second audio message is positioned in the particular area, and is configured to play the first audio message during a first period of time and to play the second audio message during a second period of time independent of an activity of the person in the particular area, and wherein each of the first audio message and the second audio message reminds the person in the particular area to engage in the particular activity or to refrain from engaging in the particular activity.

18. The system of claim 17, wherein the means for selectively playing each of the first audio message and the second audio message is configured to play each of the first audio message and the second audio message at predetermined time intervals.

19. The system of claim 17, wherein the means for selectively playing each of the first audio message and the second audio message is configured to play each of the first audio message and the second audio message at random time intervals.

20. The system of claim 17, wherein the particular activity is associated with hand hygiene.

21. The system of claim 17, wherein the particular area is one of a room and a hallway associated with a hospital.

22. The system of claim 17, wherein the means for selectively playing each of the first audio message and the second audio message comprises at least one loudspeaker.

23. A method for automatically playing audio messages reminding persons to engage in a particular activity or to refrain from engaging in the particular activity, comprising the steps of:
selecting a first audio message associated with the particular activity;
selecting a second audio message associated with the particular activity, which is different than the first audio message;
playing the first audio message during a first period of time to a person in a particular area independent of an activity of the person in the particular area; and
playing the second audio message during a second period of time after the first period of time to the person in the particular area independent of the activity of the person in the particular area, wherein each of the first audio message and the second audio message reminds the person in the particular area to engage in the particular activity or to refrain from engaging in the particular activity.

24. The method of claim 23, wherein the steps of playing the first audio message and playing the second audio message comprise the substeps of playing the first audio message and the second audio message at random time intervals.

25. The method of claim 23, wherein the particular activity is associated with hand hygiene.

26. The method of claim 23, wherein the particular area is one of a room and a hallway associated with a hospital.

27. The method of claim 23, wherein each of the first audio message and the second audio message are played via at least one loudspeaker.

28. A method for automatically playing audio messages reminding persons to engage in a particular activity or to refrain from engaging in the particular activity, comprising the steps of:
at a health care facility, selecting a first audio message associated with the particular activity;
at the health care facility, selecting a second audio message associated with the particular activity, which is different than the first audio message;
at the health care facility, playing the first audio message during a first period of time to a person in a particular area independent of an activity of the person in the particular area; and
at the health care facility, playing the second audio message during a second period of time after the first period of time to the person in the particular area independent of the activity of the person in the particular area, wherein each of the first audio message and the second audio message reminds the person in the particular area to engage in the particular activity or to refrain from engaging in the particular activity.

29. The method of claim 28, wherein the particular activity is associated with hand hygiene.

30. The method of claim 28, wherein the health care facility comprises one of a hospital, a doctor's office, and an outpatient clinic.

31. A method for automatically displaying visual messages reminding persons to engage in a particular activity or to refrain from engaging in the particular activity, comprising the steps of:
at a health care facility, selecting a visual message associated with the particular activity; and
at the health care facility, displaying the visual message to a person in a particular area independent of an activity of the person in the particular area, wherein the visual message reminds the person in the particular area to engage in the particular activity or to refrain from engaging in the particular activity.

32. The method of claim 31, wherein the particular activity is associated with hand hygiene.

33. The method of claim 31, wherein the health care facility comprises one of a hospital, a doctor's office, and an outpatient clinic.

34. A method for automatically playing audio messages reminding persons to engage in a particular activity or to refrain from engaging in the particular activity, comprising the steps of:
at a health care facility, selecting an audio message associated with the particular activity; and
at the health care facility, playing the audio message to a person in a particular area independent of an activity of the person in the particular area, wherein the audio message reminds the person in the particular area to engage in the particular activity or to refrain from engaging in the particular activity.

35. The method of claim 34, wherein the particular activity is associated with hand hygiene.

36. The method of claim 34, wherein the health care facility comprises one of a hospital, a doctor's office, and an outpatient clinic.
